(19) United States
(12) Patent Application Publication
(10) Pub. No.: US 2005/0001339 A1
(43) Pub. Date: Jan. 6, 2005

(54) Contact media for evaporative coolers

(76) Inventors: Ronald J. Yaeger, Dallas, TX (US); Galen W. Hartman, Kemp, TX (US)

Correspondence Address: THE LAW OFFICES OF H. DENNIS KELLY, 2401 TURTLE CREEK, DALLAS, TX, 75219, US

(21) Appl. No.: 10/828,893

(22) Filed: Apr. 20, 2004

Related U.S. Application Data
(63) Continuation-in-part of application No. 10/007,976, filed on Nov. 13, 2001, now abandoned.
Application No. 10/007,976 is a continuation-in-part of application No. 09/426,228, filed on Oct. 22, 1999, now abandoned.

(51) Int. Cl. B01D 47/00

(52) U.S. Cl. 261/112.2

(57) ABSTRACT

A gas/liquid contact media for use in an evaporative cooler has a fibrous material structure impregnated with a polymer-based continuous phase designed to have solubility and interfacial tension properties that promote intimate wetting with in service water while inhibiting scale deposition, and an overall cationic charge on the polymer to repel positively charged particles or ions in the water in order to further prevent scale build-up on the media.

### CROSS REFERENCE TO RELATED APPLICATIONS

This application is a continuation-in-part of copending application Ser. No. 10/007,976, filed on Nov. 13, 2001, which in turn is a continuation-in-part of copending application Ser. No. 09/426,228, filed on Oct. 22, 1999, now abandoned.

### BACKGROUND OF INVENTION

This invention relates in general to gas/liquid contact media. In particular, the invention relates to contact media for use in evaporative cooling equipment using water having dissolved and particulate contaminants.

Evaporative coolers are a popular choice for HVAC (heating/venting/air conditioning) service, especially in dry climates, as they can simultaneously cool and humidify the air, and do so with considerably less electrical power consumption than conventional refrigerant systems using fluorocarbon refrigerants. However, evaporative coolers have several problems not present with refrigerant systems, including scale build-up and the growth of mold, algae and other microbes. These problems require regular maintenance, adding to the cost of operation. The added cost of maintenance in some cases can outweigh the cost benefit of lower electrical consumption.

Water used in evaporative coolers ordinarily contains dissolved minerals such as carbonates, sulfates, and nitrates of calcium, magnesium, potassium and sodium, which deposit on the contact media as scale. As the water evaporates, the concentration of dissolved minerals increases, causing more rapid scale build-up on the contact media and the formation of particulates in the water. Scale tends to reduce the evaporative efficiency of the contact media, and will eventually clog the passages through which the water and air pass, further reducing evaporator efficiency. Moreover, the added weight from the scale deposits can cause deformation or collapse of insufficiently supported media. Depending on the makeup of ionic material dissolved in the water, the water may become acidic or alkaline, which can also promote deterioration of the contact media. Mold, algae and mildew can also develop that attack the contact media, create objectionable odors and present a potential health hazard.

Several methods have been used to address the problems of scale build-up on the contact media: 1) use of once-through water or use of recirculating water with a high bleed-off water rate to reduce the concentration of dissolved salts; 2) addition of scale inhibiting chemicals to the recirculated water; and 3) use of untreated recirculated water without bleed-off, along with periodic replacement of the contact media. All of these methods add to the operating and maintenance costs. If a replaceable contact media can be made that is long lasting and inexpensive however, the third method becomes attractive.

Replaceable contact media has been made with cellulose, asbestos, or fiberglass sheets. These materials are preferred for their large effective surface area and good wetting properties, which promotes greater evaporation rates for a given amount of material. However, materials having these desired properties often also lack the needed rigidity and water resistance to hold up under typical service for extended periods.

To improve the longevity of the contact media, it is common to impregnate the bulk material with a polymer material. Impregnation can increase the overall structure's strength, especially when wet, and thereby increase its durability and resistance to deformation caused by scale build-up. Different organic and inorganic materials have been used, with organic polymers being a popular choice.

U.S. Pat. No. 3,262,682, issued to Bredberg and U.S. Pat. No. 3,792,841, issued to Munters, teach impregnating cellulose or asbestos sheets with either a phenolic aldehyde resin or a phenolic resin to increase wet strength. Other polymers commonly used in the industry are urea formaldehyde, melamine, and melamine formaldehyde, all of which are thermosetting plastics that are cured on the bulk material. Unfortunately, these polymers tend to break down under contact with acidic or alkaline recirculated water, hydrolyzing back into the original reactants and other smaller compounds that dissolve and are washed away, leaving the bulk material unprotected and unsupported. Some of the hydrolysis products are volatile and will vaporize and be blown into the ventilation ducting along with the cooled air, polluting the air in the living space. The remaining, environmentally harmful hydrolysis products remain dissolved in the water, and are usually dumped into the local water table when the cooler is flushed out, because the environmental hazard created by this type of contact media is not generally recognized.

U.S. Pat. No. 3,798,057 and U.S. Pat. No. 3,862,280, both issued to Polvina, disclose the use of a special bulk material that is acid, alkali, and water resistant, impregnated with a combination of a chlorinated C₃ or C₅ hydrocarbon, a chlorinated terphenyl or chlorinated paraffin (as a plasticizer), and a polyglycidyl ether polyhydric phenol such as bisphenol A or bisphenol F. This impregnating material is claimed to increase durability under pH and temperature extremes that normally cause rapid disintegration of conventional contact materials.

While all the foregoing impregnating methods offer certain advantages, they also have significant drawbacks. The polymers in the prior art are anionic, meaning that they attract positively charged particles or ions, which include the dissolved metals previously discussed. Thus, these polymers aggravate scale build-up which shortens the media's useful life span. In addition, most of these polymers have values of interfacial tension that are only a fraction of the value for water, resulting in a large interfacial tension between the surface of the polymer and the water. This means that the water will not be able to wet the polymer as well as will more compatible polymers, which in turn means these materials will evaporate water at a lower rate than untreated material, given the same operating conditions and media size.

International Patent Application WO9103778 (hereafter IPA '778), filed by Myers et al., and U.S. Pat. No. 5,260,117, issued to Meyers et al., teaches impregnating a honeycomb structure with various thermosetting polymers to improve the structure's mechanical properties. A critical feature of the teachings is that the polymer precursors are dissolved in a solvent that does not dissolve the resulting polymer. The honeycomb is dipped in the solution, then heated in an oven which evaporates the solvent and is claimed to cause the precursors to react and form the final thermosetting polymer by homolineation, a reaction that results in long unbranched polymer chains without crosslinking. (The IPA '778 mistakenly describes the polymers as thermoplastic in nature, and makes numerous other errors, ascribing several characteristics to the polymer that are present in thermoplastic polymers, but not in thermosetting polymers, such as absence of crosslinking. These mistakes are substantially but not completely corrected in U.S. Pat. No. 5,260,117 [e.g. continued requirement for the absence of crosslinking in thermosetting polymers; separately applied thermosetting polymer layers are said to “fuse” together when the layers actually adhere to each other].) The polymer homologs taught in the Meyers et al. references are selected on the basis of mechanical properties such as strength, impact resistance and surface finish and appearance; there is no discussion of chemical properties such as wettability, ionic behavior, and solubility in water. Both Meyers et al. references only discuss solubility with respect to the solvent, and only polar organic solvents are specifically listed. Analysis of Meyers reveals that many of the polymer homologs will exhibit the undesirable interfacial tension and anionic behavior of the previously discussed prior art polymers; some of the listed polymers will also have hydrolysis decomposition problems.

A desirable replaceable contact media will have relatively high water resistance (i.e low solubility in water) and retain its strength when wet. The contact media should also resist scale build-up and have improved wetting properties relative to conventional polymers for greater evaporative rates. The contact media preferably will also resist growth of mold, algae, mildew and other microbes. The media should retain these properties and resist chemical breakdown in the presence of acidic or alkaline conditions. As always, a contact media that is less expensive to manufacture is also desired.

### SUMMARY OF INVENTION

In general, a structure having the desired features and advantages is achieved by a fibrous material impregnated with a compound to extend the life span and enhance performance of the contact media. The fibrous material has an effective amount of void space between the fibers for more effective surface area and to promote water distribution throughout the media. The impregnating compound has a polymer-based continuous phase designed to have solubility and surface properties within preselected limits. The polymer-based continuous phase can be made from a single type of polymer or a mixture of two or more polymers. The polymers selected for use in the compound are insoluble in water and exhibit greater stability under acidic and alkaline conditions than prior art polymers such as phenolics and phenolic aldehydes. In addition, the polymer-based continuous phase has surface tension and interfacial tension properties within preselected limits in order to ensure improved wetting by the recirculated water compared to conventional polymers. The impregnating compound is designed to be at least weakly cationic, and preferably strongly cationic in nature to enhance its resistance to scale build-up. Additives can optionally be applied to the continuous phase to resist growth of microbial species and for aesthetics such as color and fragrance. An optional discontinuous phase made up of fillers, pigments and extenders can be dispersed in the continuous phase.

The impregnating compound is present in the finished product in an amount ranging from about three to about sixty percent by weight on a dry basis, with the fibrous material making up the balance. Preferably, the impregnating compound is present in the finished product in an amount ranging from about five to about twenty-five percent by weight on a dry basis. Even more preferably, the impregnating compound in present in the finished product in an amount ranging from about ten to about fifteen percent by weight on a dry basis.

The contact media can be made in any suitable shape. The preferred configuration is a series of corrugated sheets stacked together, with adjacent sheets being canted so that the corrugations form channels for water and air flow. In an especially preferred embodiment, the sheets are arranged so that the acute angle formed by the corrugations has a thirty degree span. The stacks of sheets are preferably cut into rectangles so that a line drawn parallel to a side of the rectangle will bisect one of the angles formed by the corrugations.

The contact media of the invention overcomes several drawbacks of the prior art. Recirculating water will wet the new contact media more effectively compared to media impregnated with conventional polymers, yet the contact media has slower scale build-up rates as a result of the impregnating compound's surface properties and overall cationic nature. The impregnating compound can also be designed to be substantially insoluble in water and to be stable in either acidic or alkaline conditions.

### BRIEF DESCRIPTION OF DRAWINGS

Additional features and advantages of the invention will become apparent in the following detailed description and in the drawings, in which:

FIG. 1 is a three-dimensional representation of a solubility ‘space’, including a plot of the largest domain volume of allowed solubility parameter values.

FIG. 2 is a plot of a domain range of permissible combinations of filler specific gravity and filler weight percent in the impregnating compound.

FIG. 3 is a perspective view of a preferred configuration for the structure of the contact media.

### DETAILED DESCRIPTION

The contact media of the invention is made up of two major components, which will be labeled Component I and Component II for convenience. Component I is a fibrous material formed into a suitable shape. Component II is impregnated into and affixed to the fibrous material and has a continuous phase based on one or more polymers. Component II makes up from three to sixty percent by weight of the finished product on a dry basis. Preferably, Component II makes up from about five to about twenty-five percent by weight of the finished product, and more preferably makes up from about ten percent to about fifteen percent by weight. In each case, Component I makes up the balance of the total weight of the contact media.

Component I can be made from a number of standard fibrous materials known in the industry such as cellulose, fiberglass, and asbestos or combinations thereof. The fibrous material should have suitable rigidity, high surface area, light weight (i.e. low density), and relatively low cost, so that its regular replacement will be economically acceptable. The media can be configured in stacked arrays or formed into drip pads, sprayed pads, packed cells, rotating wheels, or other shapes.

A major portion of Component II is a continuous phase having one or more polymers, which can be either thermoplastic or thermosetting types of plastic, or a combination of both. The final weight average molecular weight of each polymer should be at least about 2500 g/mole. Suitable polymers include epoxies, polyacetals, polyacrylates, polyacrylics, polyacrylamides, polyalkylamides, polyamides, polyamideimides, polycarbonates, polycarboxylicdihydric esters, polyimides, polyesters, polycellulose acetate butyrates, polydiglycidyletheralkyl/aryldiols, polysilicones, polysiloxanes, polysiloxides, polystyrenes, polysucrose acetate butyrates, polysulfonamides, polysulfones, polyurethanes, polyvinylacetals, and polyvinylhalogens. The polymer can be one of the above enumerated types, or a combination of two or more types, as well as copolymers of the above in whole or in part, and other polymers known in the art or that will become known in the art as substitutes. The polymers used should be stable in acidic and alkaline conditions normally encountered in recirculating water. Component A can optionally include transient and/or permanent plasticizers such as dialkyl/aryl phthalates, dialkyl/aryl adipates, dialkyl/aryl maleates, dialkyl/aryl succinates, dialkyl/aryl sebacates, polyalkyl/aryl phosphates, polyesters, and condensation polymers and resins known in the art as plasticizers and flexibilizers.

Throughout the following discussion, the law of mixtures is assumed to apply when calculating overall physical and chemical parameters. That is, the value of a particular parameter for a mixture having two or more components is equal to the sum of the products of each component's parameter value times that component's mole fraction. Expressed in mathematical terms:
Vₜₒₜₐₗ=ρVᵢxᵢ (i=1 to n; Σxᵢ=1) 1)
where V is the parameter value and Xᵢ is the mole fraction of the ith component.

The solubility of a material, whether pure compound or a mixture (or an ingredient within a mixture), can be described by three solubility parameters, which will be represented for convenience by the symbols δₙ, δₚ, and δₕ. These parameters are measures of the solubility of the material with respect to the nonpolar, polar, and hydrogen-bonding aspects of the material, respectively, and are expressed in units of g-cal/mole. They can be determined experimentally, or calculated by a method to be discussed. The nonpolar parameter δₙ mainly describes the physical aspects of the material's solubility, while the polar and hydrogen-bonding parameters δₚ and δₕ primarily describe the chemical aspects of the solubility of the material. If these three parameters are viewed as the axes of a three-dimensional solubility ‘space’ describing all possible combination of values for the three parameters of the solubility space, then for any particular combination of δₙ, δₚ, and δₕ there is a total solubility parameter, represented by δₜ, equal to the geometric distance in the solubility space from the axis origin to the point in the solubility ‘space’ with the particular values for δₙ, δₚ, and δₕ. Using classic analytical geometry, the total solubility parameter δₜ is the positive root of the sum of the squares of the solubility parameters described in the following equation:
δₜ=\sqrt{δₕ²+δₙ²δₚ²} 2)
The total solubility parameter δₜ can also be derived using the Haggenmacher equation for vapor pressure, which can be expressed as:

$${δ}_{t} = \sqrt{\frac{RTd}{M} \sqrt{1 - \frac{{PT}_{c}^{3}}{{P}_{c} {T}^{3}}} ⌊ \frac{2.303 BT}{{( t + C )}^{2}} - 1 ⌋} \qquad 3 )$$

where R=Gas constant=1.987 cal/mole/° K.; T_{b}=Boiling temperature, ° K.; T_{c}=Critical temperature, ° K; M=Molecular weight, g/mole; P=Pressure, mm of Hg; T=Absolute Temperature, ° K; t=Temperature, ° C.; d=Density, g/ml; P_{c}=Critical pressure, mm of Hg; and A,B,C=constants in Antoine's equation log P=−B/(t+C)+A. In most cases, the Antoine equation can be used to find the values for T_{b} at 760 mm of Hg and the vapor pressure P at 25° C. The significance of the solubility parameters will become apparent in the following discussion.

We can define a dimensionless aggregation constant, represented by α, that describes the tendency of a chemical component to associate with itself, and that is determined by the relationship:
log α=3.39068(T_{b}/T_{c})−0.15848−log(M/d) 4)
the polar parameter δₚ and the hydrogen bonding parameter δₕ can then be expressed in terms of the aggregation constant α and the total solubility parameter δₜ by the following equations:

$$\begin{matrix}{δ}_{p} = {δ}_{t} \sqrt{\frac{Σ {F}_{p}}{α Σ {F}_{t}}} & 5 ) \\ {δ}_{h} = {δ}_{t} \sqrt{\frac{α - 1}{α}} & 6 )\end{matrix}$$

where Fₚ and Fₜ are the molar cohesion constants for the individual compounds at constant pressure and constant temperature, respectively. These constants are based on the chemical structural identity of the polymers. Tables of these constants for various chemical functional groups, found by experiment, are available from sources such as the CRC Press, Inc., “Handbook of Chemistry and Physics,” 63rd Edition, 1 982-1983, pages C-732 to C-734. Values for some common functional groups are listed in Table 1. Having determined δₚ and δₕ, the nonpolar parameter δₙ can then be derived from Eq. (2):
δₙ=\sqrt{δₜ²−(δₚ²δₕ²)} 7)

TABLE 1
Molar Cohesion Constants And Lyderson Chemical Group Constants

| | | | | | | | Lyderson Chemical | | |
|---|---|---|---|---|---|---|---|---|---|
| | | Molar | Molar | Volume | | | Group Constants | | |
| Chemical | Chemical | Cohesion | Cohesion | Constant | Aliphatic | Cyclic | | Aliphatic | Cyclic |
| Group | Bond Type | Fₜ | Fₚ | V_{Tg} | delta T | delta T | delta Pₜ | delta P | delta P |
| —CH3 | alkyl | 148.30 | 0.00 | 21.548 | 0.020 | 0.000 | 0.0226 | 0.227 | 0.000 |
| —CH2— | alkyl | 131.50 | 0.00 | 15.553 | 0.020 | 0.013 | 0.0200 | 0.227 | 0.184 |
| >CH— | alkyl | 86.00 | 0.00 | 9.557 | 0.012 | 0.012 | 0.0131 | 0.210 | 0.192 |
| >C< | alkyl | 32.00 | 0.00 | 3.562 | 0.000 | −0.007 | 0.0040 | 0.210 | 0.154 |
| CH2═ | olefinic | 126.50 | 32.70 | 19.173 | 0.018 | 0.000 | 0.0192 | 0.198 | 0.000 |
| —CH═ | olefinic | 121.50 | 29.10 | 13.178 | 0.018 | 0.011 | 0.0184 | 0.198 | 0.154 |
| >C═ | olefinic | 84.50 | 30.80 | 7.183 | 0.000 | 0.011 | 0.0129 | 0.198 | 0.154 |
| —CH═ | aromatic | 117.30 | 30.40 | 13.417 | 0.000 | 0.011 | 0.0178 | 0.000 | 0.154 |
| >C═ | aromatic | 98.10 | 31.70 | 7.422 | 0.000 | 0.011 | 0.0149 | 0.000 | 0.154 |
| —0— | ether | 115.00 | 105.60 | 6.462 | 0.021 | 0.014 | 0.0175 | 0.160 | 0.120 |
| —0— | acetal | 115.50 | 5.00 | 6.462 | 0.011 | 0.020 | 0.0225 | 0.090 | 0.120 |
| —0— | oxirane | 176.20 | 76.20 | 6.462 | 0.000 | 0.027 | 0.0267 | 0.000 | 0.120 |
| —COO— | ester | 326.60 | 256.20 | 23.728 | 0.047 | 0.000 | 0.0497 | 0.700 | 0.000 |
| >C═O | ketone | 263.00 | 257.00 | 17.265 | 0.040 | 0.033 | 0.0400 | 0.290 | 0.020 |
| —CHO | aldehyde | 292.64 | 259.90 | 23.261 | 0.048 | 0.000 | 0.4450 | 0.330 | 0.050 |
| >(CO)20 | anhydride | 567.30 | 567.00 | 40.993 | 0.086 | 0.000 | 0.0863 | 0.760 | 0.000 |
| —COOH | acid | 276.10 | 203.20 | 26.102 | 0.039 | 0.000 | 0.0390 | 0.700 | 0.000 |
| —OH—> | H-bond | 237.50 | 237.50 | 10.647 | 0.082 | 0.000 | 0.0343 | 0.060 | 0.000 |
| —OH | primary | 329.40 | 329.40 | 12.457 | 0.082 | 0.000 | 0.0493 | 0.060 | 0.000 |
| —OH | secondary | 289.20 | 289.20 | 12.457 | 0.082 | 0.000 | 0.0440 | 0.060 | 0.000 |
| —OH | tertiary | 390.40 | 390.40 | 12.457 | 0.082 | 0.000 | 0.0593 | 0.060 | 0.000 |
| —OH | phenolic | 171.00 | 171.00 | 12.457 | 0.035 | 0.000 | 0.0060 | −0.020 | 0.000 |
| —NH2 | amino 1 | 226.60 | 226.60 | 17.012 | 0.031 | 0.000 | 0.0345 | 0.095 | 0.000 |
| —NH— | amino 2 | 180.00 | 180.00 | 11.017 | 0.031 | 0.024 | 0.0274 | 0.135 | 0.090 |
| >N— | amino 3 | 61.10 | 61.10 | 12.569 | 0.014 | 0.007 | 0.0093 | 0.170 | 0.130 |
| —C═N | nitrile | 354.60 | 354.20 | 23.066 | 0.060 | 0.000 | 0.0539 | 0.360 | 0.000 |
| —NCO | isocyanate | 358.70 | 4.00 | 25.907 | 0.054 | 0.000 | 0.0539 | 0.460 | 0.000 |
| HCON< | formamide | 497.20 | 354.00 | 35.830 | 0.062 | 0.000 | 0.0546 | 0.500 | 0.000 |
| —CONH— | amide | 554.70 | 437.00 | 28.302 | 0.071 | 0.000 | 0.0843 | 0.425 | 0.000 |
| —CONH2 | amide | 589.90 | 483.60 | 34.297 | 0.071 | 0.000 | 0.0897 | 0.385 | 0.000 |
| OCONH | urethane | 616.90 | 436.20 | 34.784 | 0.078 | 0.000 | 0.0938 | 0.605 | 0.000 |
| —S— | thioether | 209.40 | 209.40 | 18.044 | 0.015 | 0.008 | 0.0318 | 0.270 | 0.240 |
| —SH | thiohydride | 215.60 | 211.30 | 24.039 | 0.015 | 0.000 | 0.0150 | 0.270 | 0.000 |
| Cl | primary | 205.10 | 150.00 | 19.504 | 0.017 | 0.000 | 0.0311 | 0.320 | 0.000 |
| Cl | secondary | 208.30 | 154.00 | 19.504 | 0.017 | 0.000 | 0.0317 | 0.320 | 0.000 |
| Cl | twinned | 342.70 | 275.00 | 39.008 | 0.034 | 0.000 | 0.0521 | 0.040 | 0.000 |
| Cl | aromatic | 161.00 | 39.80 | 19.504 | 0.017 | 0.000 | 0.0245 | 0.320 | 0.000 |
| Br | primary | 257.90 | 60.00 | 25.305 | 0.010 | 0.000 | 0.0392 | 0.500 | 0.000 |
| Br | aromatic | 205.60 | 49.00 | 25.305 | 0.010 | 0.000 | 0.0313 | 0.500 | 0.000 |
| F | primary | 41.30 | 35.80 | 11.200 | 0.018 | 0.000 | 0.0060 | 0.224 | 0.000 |
| Conjugation | | 23.26 | −9.70 | 0.000 | 0.000 | 0.000 | 0.0035 | 0.000 | 0.000 |
| cis | | −7.13 | −7.10 | 0.000 | 0.000 | 0.000 | −0.0010 | 0.000 | 0.000 |
| trans | | −13.50 | −13.50 | 0.000 | 0.000 | 0.000 | −0.0020 | 0.000 | 0.000 |
| 4 member | ring | 77.76 | 98.00 | 0.000 | 0.000 | 0.000 | 0.0118 | 0.000 | 0.000 |
| 5 member | ring | 20.99 | 41.50 | 0.000 | 0.000 | 0.000 | 0.0030 | 0.000 | 0.000 |
| 6 member | ring | −23.44 | 29.80 | 0.000 | 0.000 | 0.000 | −0.0035 | 0.000 | 0.000 |
| 7 member | ring | 45.10 | 0.00 | 0.000 | 0.000 | 0.000 | 0.0069 | 0.000 | 0.000 |
| bicycloheptane | ring | 22.56 | 0.00 | 0.000 | 0.000 | 0.000 | 0.0034 | 0.000 | 0.000 |
| tricyclodecane | ring | 62.47 | 0.00 | 0.000 | 0.000 | 0.000 | 0.0095 | 0.000 | 0.000 |
| base value | | 135.10 | 0.00 | 0.000 | 0.000 | 0.000 | 0.0000 | 0.000 | 0.000 |
| ortho substitution | | 9.70 | −6.50 | 0.000 | 0.000 | 0.000 | 0.0015 | 0.000 | 0.000 |
| meta substitution | | 6.60 | −11.90 | 0.000 | 0.000 | 0.000 | 0.0010 | 0.000 | 0.000 |
| para substitution | | 40.30 | −16.50 | 0.000 | 0.000 | 0.000 | 0.0060 | 0.000 | 0.000 |

The preceding equations for finding δₙ, δₚ, and δₕ are based on data for molecular weights less than about 1000. As the molecular weight of a polymer increases, values for δₙ, δₚ, and δₕ shift slightly from the values for the lower molecular weight analogs. Calculating this shift and effect, the number of monomer units n can be determined by the following equation:
n=1/(2ΣΔPₜ) 8)
where ΣΔPₜ is the sum of the aggregation constants for the repeating unit of the segment in the polymer chain. The total solubility parameter for the polymer can then be expressed as:
δₜ=(nΣFₜ+135)/(nΣV_{Tg}) 9)
where ΣΔV_{Tg} is the sum of the group molar volume constants for the repeating unit at the glass transition temperature. We can define a chain aggregation number, symbolized by α*, that represents the aggregation constant for a polymer chain having a weight average molecular weight greater than about 1000. The chain aggregation number is applied in the same manner as the lower molecular value α, and can be calculated from the following equation:
α*=(777.4ΣP_{T})/ΣVₘ 10)
where ΣVₘ is the sum of the molar volumes of the repeating units. The high molecular weight polymer solubility parameters δₙ, δₚ, and δₕ can then be calculated by using α* in place of α in equations 5, 6, and 7.

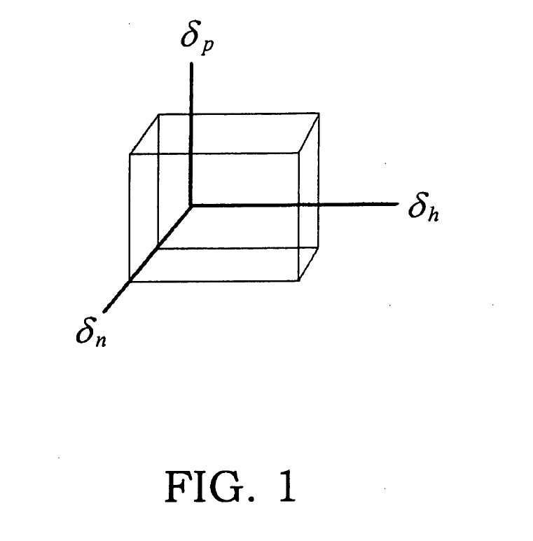

To ensure that the impregnating compound is insoluble in water, the three solubility parameters for the polymer mixture are limited to specific ranges. Table 2 lists the range limits as minimum and maximum values for three embodiments, listed from left to right in increasing amount of preference. To aid in visualizing the range of possible values for the solubility parameters, FIG. 1 shows the volume domain defined in the solubility ‘space’ by the ranges of the solubility parameters for the embodiment having the largest range of values. The volume domain is a rectangular solid offset from the origin along the nonpolar parameter δₙ axis by 6.5 g-cal/mole, the minimum value for δₙ. The three embodiments of Table 2 would be represented by three nested rectangular solids, like boxes in boxes.

TABLE 2
Solubility Parameter Limits

| | | | More | | Most | |
|---|---|---|---|---|---|---|
| Solubility | Preferred | | Preferred | | Preferred | |
| Parameter | Min. | Max. | Min. | Max. | Min. | Max. |
| δₚ | 0.0 | 8.5 | 2.5 | 7.5 | 3.0 | 5.5 |
| δₕ | 0.0 | 7.0 | 0.7 | 5.0 | 1.0 | 4.0 |
| δₙ | 6.5 | 8.5 | 6.5 | 8.5 | 6.5 | 8.5 |

Table 3 lists five examples of polymer mixtures that can be used to make an impregnating compound continuous phase having solubility parameters falling within the specified ranges in Table 2. The resulting solubility parameters for each example are listed in Table 4 in g-cal/mole. In both tables, values listed for individual components in each example are expressed as weight percent.

TABLE 3

| Component | | | | | | | | |
|---|---|---|---|---|---|---|---|---|
| Name | δₙ | δₚ | δₕ | Ex. 1 | Ex. 2 | Ex. 3 | Ex. 4 | Ex. 5 |
| Polyvinyl | 7.55 | 5.50 | 3.37 | — | — | 40 | — | — |
| chloride | | | | | | | | |
| Poly- | 6.75 | 7.94 | 6.62 | — | — | — | — | 20 |
| acrylonitrile | | | | | | | | |
| Poly- | 7.42 | 5.01 | 2.94 | — | — | 60 | — | — |
| methacrylate | | | | | | | | |
| Poly- | 7.84 | 7.11 | 6.43 | 100 | — | — | 70 | — |
| amideimide | | | | | | | | |
| Poly- | 7.90 | 4.28 | 3.54 | — | 100 | — | — | — |
| butylacrylate | | | | | | | | |
| Polystyrene | 8.17 | 4.03 | 2.38 | — | — | — | 30 | 40 |
| Polybutadiene | 6.36 | 2.93 | 3.32 | — | — | — | — | 40 |
| | | | Total | 100 | 100 | 100 | 100 | 100 |

TABLE 4

| Solubility Parameters | | | | | |
|---|---|---|---|---|---|
| of Component A: | Ex. 1 | Ex. 2 | Ex. 3 | Ex. 4 | Ex. 5 |
| δₙ | 7.84 | 7.90 | 7.47 | 7.94 | 7.16 |
| δₚ | 7.11 | 4.28 | 5.21 | 6.19 | 4.37 |
| δₕ | 6.43 | 3.54 | 3.11 | 5.22 | 3.60 |

When two or more polymers are mixed to create the impregnating compound, the compatibility of the polymer components should be considered. The degree of compatibility between any two components is proportional to the distance between the points that represent the two polymers in the solubility ‘space’. A shorter distance between the points represents greater compatibility between the polymers. Where more than two polymers are in the mixture, it is necessary to determine each polymer's molar fraction in the mixture where all the molar fractions add up to 1. Then, applying the law of mixtures and averaging, each polymer's solubility parameters are multiplied by its molar fraction, and the products are averaged together to find the geometric mean location of the polymer mixture. Calculating the distance between an individual polymer's location in solubility ‘space’ and the geometric mean location of the polymer mixture in solubility ‘space’ will identify the compatibility of an individual polymer with the mixture.

The polymer mixture is designed to be insoluble with both water and the scale-depositing species in the water. The scale depositing species dissolve relatively well in water because of their high solubility (i.e. proximity in the solubility ‘space’) with water. For both the water and the scale depositing species the value for δₕ, (the hydrogen-bonding parameter) is much greater than the values for the polar and nonpolar parameters. In contrast, the polymer mixture is designed to have a value for the hydrogen-bonding parameter that is much smaller than the value for either the water or the scale-depositing species. The difference in relative sizes of the hydrogen-bonding parameters is the main reason why the polymer is insoluble with both the water and the scale-depositing species. The insolubility of the polymer with the scale-depositing species helps to prevent any initial deposition of scale on the polymer surface. This is very important, because once a monoatomic scale layer is deposited on the polymer surface, the polymer effectively has little or no influence on the scale build-up rate. The scale build-up rate is then governed by the affinity of scale-depositing species to bond to the existing scale layer. This affinity results in a scale build-up rate that is exponentially greater than the rate at which the scale will deposit on the polymer.

The previous discussion has described the means for selecting polymers to achieve the required solubility characteristics. Means for achieving the necessary surface tension and interfacial tension properties of the impregnating compound's continuous phase will now be discussed.

Surface tension is the attractive force exerted by the molecules below a material's surface upon the molecules at a solid/gas or liquid/gas interface. This force results from the high molecular concentration of a liquid or solid compared to the low molecular concentration of a gas, as well as upon other factors to be discussed below. The result of this force, put simply, is that an inward pull, or internal pressure, is created that tends to restrain the liquid or solid from flowing. Its strength varies with the chemical nature of the liquid or solid. The higher the surface tension, the greater the resistance to flow of the liquid or solid into the gas.

Interfacial tension describes behavior at solid/solid, liquid/liquid, and solid/liquid interfaces. Higher interfacial tensions yield less intimate contact of the components on each side of the interface. For solid/liquid interfaces, this means there will be less wetting of the interfacial surface by the liquid. As in the case of solubility, the impregnating compound needs to be designed with surface tensions and interfacial tensions within acceptable limits so that water will intimately contact the impregnated media to achieve optimal evaporation rates. Distinction will be made between pure water and typical in-service water, when the distinction is relevant.

Surface tension, represented by γ, is the reversible work required to create a unit surface area of (solids and liquids)/gas interface at constant temperature, pressure, and chemical composition, expressed mathematically as:
γ=(∂G/∂A)_{T,P,n} 11)
where γ is the surface tension, G the Gibbs free energy of the system, and A the surface area of the interface. The specific surface free energy fₕ is the free energy per unit surface area, which can be expressed for a system having n components as a function of the surface tension and the component concentrations as follows:
fₕ=γ+ΣCᵢμᵢ (for i=1 to n) 12)
where Cᵢ is the surface concentration (number of moles per unit area) of component i, and μᵢ is the chemical potential of component i. Rearranging Eq. 12 gives:
γ=fₕ−ρCᵢμᵢ 13)
which means the surface tension is equal to the specific surface free energy in excess of the bulk phase. Surface and interfacial tensions are influenced most greatly by the chemical composition of the components which defines the predominance of the surface free energy, surface concentration, and the chemical potential of the components in accordance with equation 13.

In the same manner as with solubility, surface tension can be separated into nonpolar (dispersion), polar, and hydrogen bonding components:
γ=γ_{d}+γₚ+γₕ
where γd is the dispersion component arising from dispersion force interaction, γp the polar component arising from various dipolar and polar interactions, and γh the hydrogen bonding component arising from the hydrogen bonding character and tendency. The dispersion component γd, the polar component γp, and the hydrogen bonding component γh are calculated from the previously discussed solubility parameters:
γ_{d}=γ(δₙ/(δₙ+δₚδₕ)) 15)
γₚ=γ(δₚ/(δₙ+δₚδₕ)) 15)
γₕ=γ(δₕ/(δₙ+δₚδₕ)) 15)

The interfacial tension can be calculated from the surface tension and the dispersion, polarity, and hydrogen bonding components of the two contiguous phases using the harmonic mean equation, shown in C. M. Hansen, “The Three Dimensional Solubility Parameter and Solvent Diffusion Coefficient”, Danish Technical Press, Copenhagen, 1967 and in S. Wu, “Polymer Interface and Adhesion”, Marcel Dekker, New York, 1982:
γ₁₂=γ₁+γ₂−4γ_{1d}γ_{2d}/(γ_{1d}+γ_{2d})−4γ₁ₕγ₂ₕ/(γ₁ₕ+γ₂ₕ) 18)
or by using the Berthelot's geometricequation found in D. H. Kaelble, “Physical Chemistry of Adhesion,” Wiley, New York, 1971; F. M. Fowkes, “Chemistry and Physics of Interfaces,” American Chemical Society, Washington, DC, 1965; and in D. K. Owens and R. C. Wendt, J. Applied Polymer Science, 13, 1741, 1969:
γ₁₂=γ₁+γ₂−2(γ_{1d}γ_{2d})^{0.5}−2(γ₁ₚγ₂ₚ)^{0.5}−2(γ₁ₕγ₂ₕ)^{0.5}
where the subscripts 1 and 2 refer to the two individual phases. The harmonic-mean equation (equation 18) has been shown to predict the interfacial tensions between polymers more accurately than the geometric-mean equation (equation 19).

Careful consideration should be given during design of the impregnating compound to the surface chemical constitution and the surface tensions of chemical groups at the interfacial surface, as these factors will influence the magnitude of the total interfacial tension when the in-service water contacts the impregnating compound. Table 5 lists the surface tension of various surface chemical groups. The hydrocarbon groups present at the interfacial surface contribute relatively medium surface tensions, while fluorocarbon groups contribute low to medium surface tensions, chlorohydrocarbon groups contribute high surface tensions, and silicone groups contribute low surface tensions. Water has a relatively large value for surface tension, about 73 dyne/cm at 20° C., so designing the impregnating compound to have a similarly large value of surface tension will aid wetting of the surface by the water. Some low surface tension polymers and/or surface chemical groups can be combined with high surface tension polymers to yield mixtures having intermediate surface tension values while remaining within the surface tension design ranges identified below.

TABLE 5
Surface Chemical Constitution and Surface Tension

| | |
|---|---|
| | Surface Tension at 20° C. |
| Surface Chemical Groups | (dyne/cm = mN/m) |

Hydrocarbon Surfaces

| | |
|---|---|
| —CH3 | 30 |
| —CH2— | 36 |
| —CH2— & ::CH:: | 43 |
| ::CH:: phenyl ring edge | 45 |

Fluorocarbon Surfaces

| | |
|---|---|
| —CF3 | 15 |
| —CF2H | 26 |
| —CF3 & —CF2— | 17 |
| —CF2— | 23 |
| —CH2CF3 | 23 |
| —CF2—CFH— | 30 |
| —CF2—CH2— | 33 |
| —CFH—CH2— | 37 |

Chlorohydrocarbon Surfaces

| | |
|---|---|
| —CHCl—CH2— | 42 |
| —CCl2—CH2— | 45 |
| ═CCl2 | 50 |

Silicone Surfaces

| | |
|---|---|
| —O—Si(CH3)2—O— | 20 |
| —O—Si(CH3)(C6H5)—O— | 26 |

Values for surface and interfacial tensions are tabulated on pages VI-414 to VI-432 in J. Brandrup and E. H. Immergut, “Polymer Handbook”, 3rd Edition, John Wiley & Sons, 1989. This reference also lists surface tension and interfacial tension values for polymers and polymer/polymer systems, as well as other coefficients and data.

Values for surface tension and interfacial tension can be determined by experiment. One well known method makes use of a plot sometimes referred to as a Zisman Plot, that is more fully described in W. A. Zisman, “Relation of the Equilibrium Contact Angle to Liquid and Solid Constitution,” Advances in Chemistry Series, No. 43, 1964. To create the Zisman plot, a drop of liquid is placed on the surface of a polymer. The contact angle formed by the drop of liquid is measured, and the cosine of this angle is plotted on a vertical axis against the measured or known surface tension of the liquid on a horizontal axis. This process is repeated for a number of different liquids with the same polymer in order to create the Zisman plot. A curve drawn through the data points is substantially linear, and can be extrapolated out to an intersection with a horizontal line drawn at cosine=1 (i.e. where the contact angle equals zero). The interfacial tension value at this intersection is called the critical surface tension γ_{c}. Liquids at the critical surface tension γ_{c} would completely wet the polymer surface with a contact angle of zero degrees. The following equations identify the relationship of surface tension and contact angle: where γₛ is the surface tension of the solid phase; γₗ is the surface tension of the liquid phase; Πₑ is the equilibrium spreading pressure; and Θ is the contact angle. Equations 20 and 21 and the critical surface tension can then be used to find surface tensions and interfacial tension for a particular system.

Experimentation has shown that, for the desired wetting properties, the interfacial tension of the impregnating compound/in-service water interface needs to fall within specific limits. Table 6 lists the minimum and maximum values for three preferred ranges, listed from left to right in increasing amount of preference as in Table 2.

TABLE 6

| Surface/ | Preferred | | More Preferred | | Most Preferred | |
|---|---|---|---|---|---|---|
| Interfacial Tension | Min. | Max. | Min. | Max. | Min. | Max. |
| γₛₜ | 20 | 70 | 30 | 68 | 40 | 68 |
| γᵢₜ | 0 | 30 | 0 | 23 | 0 | 15 |

Tables 7 and 8 list the surface tension and interfacial tension values of the example polymer components for the five example polymer mixtures listed in Table 3. Table 7 lists values with pure water as the liquid, while Table 8 is for typical in-service water. As in Table 3, the values listed for individual components in each example are expressed as weight percent. Table 9 lists the surface and interfacial tensions for the resulting impregnating compound continuous phases for both Tables 7 and 8.

TABLE 7
Surface Tension and Interfacial Tension of
Various Components with Pure Water

| Component Name | γst | γit, H2O | Ex. 1 | Ex. 2 | Ex. 3 | Ex. 4 | Ex. 5 |
|---|---|---|---|---|---|---|---|
| Polyvinyl chloride | 40 | 23.7 | — | — | 40 | — | — |
| Polyacrylonitrile | 43 | 13.7 | — | — | — | — | 20 |
| Polymethacrylate | 36 | 26.7 | — | — | 60 | — | — |
| Polyamideimide | 42 | 15.8 | 100 | — | — | 70 | — |
| Polybutylacrylate | 32 | 28.3 | — | 100 | — | — | — |
| Polystyrene | 41 | 29.9 | — | — | — | 30 | 40 |
| Polybutadiene | 33 | 27.0 | — | — | — | — | 40 |
| | | Total | 100 | 100 | 100 | 100 | 100 |

TABLE 8
Surface Tension and Interfacial Tension of
Various Components with In-Service Water

| Component Name | γst | γit, H2O+ | Ex. 1 | Ex. 2 | Ex. 3 | Ex. 4 | Ex. 5 |
|---|---|---|---|---|---|---|---|
| Polyvinyl chloride | 40 | 18.5 | — | — | 40 | — | — |
| Polyacrylonitrile | 43 | 9.3 | — | — | — | — | 20 |
| Polymethacrylate | 36 | 20.9 | — | — | 60 | — | — |
| Polyamideimide | 42 | 11.1 | 100 | — | — | 70 | — |
| Polybutylacrylate | 32 | 21.8 | — | 100 | — | — | — |
| Polystyrene | 41 | 24.6 | — | — | — | 30 | 40 |
| Polybutadiene | 33 | 20.7 | — | — | — | — | 40 |
| | | Total | 100 | 100 | 100 | 100 | 100 |

TABLE 9
Surface and Interfacial Tensions of Continuous Phase

| | | Ex- | Ex- | Ex- | Ex- |
|---|---|---|---|---|---|
| Property | Example 1 | ample 2 | ample 3 | ample 4 | ample 5 |
| Surface Tension | 42.0 | 32.0 | 37.6 | 41.7 | 38.2 |
| (dyne/cm) | | | | | |
| Interfacial Tension | 15.8 | 28.3 | 25.5 | 20.0 | 25.5 |
| with pure water | | | | | |
| (dyne/cm) | | | | | |
| Interfacial Tension | 11.1 | 21.8 | 21.5 | 15.2 | 20.0 |
| with in-service water | | | | | |
| (dyne/cm) | | | | | |

The polymer mixture is designed to have higher surface tensions (and therefore lower interfacial tensions with water) than polymers used in the prior art contact media. As a result, in-service water will have more intimate contact with the polymer mixture than it will with prior art polymers. Thus, it seems that more scale depositing will occur with the polymer mixture than with the prior art contact media, which would be undesirable. Fortunately, the tendency for scale build-up is not as great as it seems, due to other factors designed into the polymer mixture that oppose scale deposition. One of these is the high degree of difference of the solubility parameters of the polymer mixture and the scale-depositing species, as was previously discussed. A second factor is the choice of polymers that are generally cationic in nature, so that the polymer will repel positively charged ions and particles in the water.

Polymers are composed of cationic and anionic groups, present as part of the polymer backbone and as pendant structures attached to the backbone. Pendant ionic groups have much more ionic character and influence than do those in the backbone. Therefore, polymers having a high density of pendant cationic groups are preferred. Table 10 schematically depicts nine examples of pendant groups, showing how they bond to the polymer backbone. Rp represents a cationic group and Rn represents an anionic group. The formula groups are illustrated in decreasing order of cationic character from top left to bottom right:

TABLE 10

| | | |
|---|---|---|
| 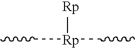 | 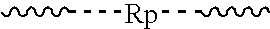 | 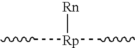 |
| 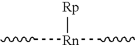 | 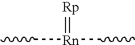 | 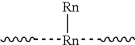 |
| 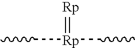 | 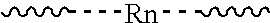 | 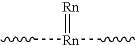 |

Table 11 lists a number of organic cationic groups that can be substituted for Rp in Table 10. Like Table 10, the groups are shown in decreasing order of cationic strength from top left to bottom right. Likewise, Table 12 lists a number of organic anionic groups that can be substituted for Rn in Table 10, in decreasing order of cationic strength (i.e. increasing order of anionic strength) from top left to bottom right.

TABLE 11
Cationic Chemical Groups

| Chemical | Chemical | Chemical | Chemical |
|---|---|---|---|
| Group | Bond | Group | Bond |
| —NH2 | amino 1 | bicycloheptane | ring |
| —CH3 | alkyl | 6 member | ring |
| base value | | >C< | alkyl |
| —CH2— | alkyl | 7 member | ring |
| CH2═ | olefinic | 4 member | ring |
| —CH═ | olefinic | conjugation | |
| >CH— | alkyl | cis | |
| >C═ | olefinic | 5 member | ring |
| trans | | tricyclodecane | ring |

TABLE 12
Anionic Chemical Groups

| Chemical | Chemical | Chemical | Chemical |
|---|---|---|---|
| Group | Bond | Group | Bond |
| meta substituent | | —OH--> | H-bond |
| ortho substituent | | Cl | aromatic |
| F | primary | >C═O | ketone |
| para substituent | | —COOH | acid |
| Br | aromatic | —OH | secondary |
| >N— | amino 3 | —CHO | aldehyde |
| >C═ | aromatic | —COO— | ester |
| —0— | ether | —OH | primary |
| —0— | acetal | Cl | tertiary |
| —CH═ | aromatic | —C═N | nitrile |
| Cl2 | twinned | —NCO | isocyanate |
| —OH | phenolic | —OH | tertiary |
| —0— | oxirane | HCON< | formamide |
| —NH— | amino 2 | —CONH— | amide |
| Cl | primary | >(CO)20 | anhyride |
| Br | primary | —CONH2 | amide |
| Cl | secondary | OCONH | urethane |
| —S— | thioether | | |

Metallic ions can also be used as pendant groups to give the polymer cationic behavior. Using Tables 11 and 12, polymers can be selected having overall cationic behavior.

In addition to the polymer mixture already described, the impregnating compound can optionally include one or more of the following materials: (1) fillers and/or extenders in particulate or fibrous form, (2) glass particulates and fibers, and (3) pigments. These materials are present as a discontinuous phase that is evenly dispersed in the continuous phase of the polymer mixture. The discontinuous phase can include materials such as carbon blacks, calcium silicates, calcium carbonates, aluminum silicates, calcium sulfates, barium sulfates, silicon dioxides, aluminum/silicon oxides, magnesium silicates, potassium/aluminum silicates, calcium silicates, cellulosic particulates and fibers, and glass particulates and fibers. The discontinuous phase can make up as much as about forty percent of the total weight of the impregnating compound. The pigments, fillers and extenders can be materials having high thermal conductivity such as particulate aluminum, graphite, and carbon black to increase the thermal transfer between the contact media and the surrounding environment.

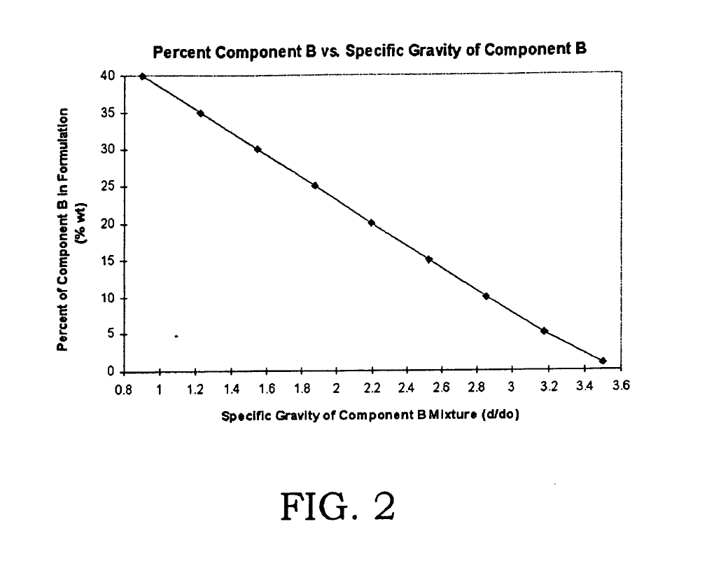

The ingredients of the discontinuous phase need to remain evenly dispersed in the polymer mixture until the impregnating compound becomes viscous enough to ensure uniformity of the chemical and physical properties throughout the contact media. Also, the sum of discontinuous phase density and weight percentage should be low enough to prevent the contact media from collapsing under its own weight in use. FIG. 2 depicts a graph of the weight percentage of the impregnating compound due to the discontinuous phase along the vertical axis versus the specific gravity of the discontinuous phase along the horizontal axis. The curve plotted on the graph is the upper constraint on permissible combinations of weight percentage of filler content and specific gravity, with the area below the curve being the permissible range. As can be appreciated from FIG. 2, as the percentage of Component B in the impregnating compound is increased, the maximum allowable specific gravity of the discontinuous phase decreases, and visa versa. The curve of FIG. 2 can be expressed as fourth power polynomial equations, where x represents the specific gravity of the Component B mixture and y represents the percent of the impregnating compound made up by the discontinuous phase:
x=5E-07y⁴−5E-05y³+0.0016y²−0.0852y+3.5789 22)
y=0.3656x⁴−2.8743x³+8.0047x²−24.667x+57.599 23)

In addition to the polymer mixture and the optional discontinuous phase, the impregnating compound can optionally include compounds to prohibit the growth of molds, fungi, mildew, algae, bacteria, and other microorganisms. These additives can make up as much as thirty percent by weight of the impregnating compound. Some suggested compounds include metallic oxides (such as titanium oxide, antimony oxide, zinc oxide, and cuprous oxide), cationic metaborates, boric acid, cationic carbonates, alkyl/aryl chlorides, arylmetalosalicilates, arylmetalooleates, quinolinates, and alkylarylchlorophenols. Since some of these materials can become part of the continuous phase, care should be taken when choosing these components to maintain the solubility, surface tension, and interfacial tension properties of the continuous phase within the ranges previously described, as well as to maintain overall cationic character of the impregnating compound.

Pigment and fragrances can optionally be added as well for aesthetic appeal, and can make up as much as four percent by weight of the impregnating compound. Care should also be taken when choosing these additives to maintain the solubility, surface tension, and interfacial tension properties within the ranges previously described, as well as to maintain overall cationic character of the impregnating compound.

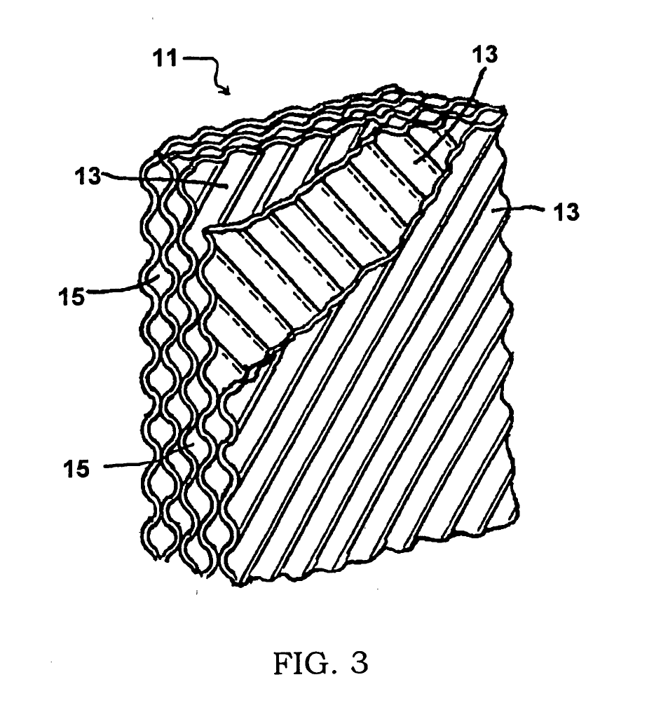

FIG. 3 shows the preferred structural configuration of the contact media 11 of the invention. The media is made up of several individual sheets 13 of impregnated fibrous material, shaped into corrugated sheets and stacked together with the corrugations in adjacent sheets at different angles to form channels 15 for water and air flow. In an especially preferred embodiment, the sheets are arranged so that each of the acute angles formed by the corrugations has a thirty degrees span. The stacks of sheets are preferably cut into rectangles with the acute angles oriented symmetrically about one of the rectangle's centerlines.

The impregnating compound can be applied to the fibrous material in a single layer, or applied in a series of layers that will adhere together. The impregnating compound can be applied so that the Component I fibrous material's surface area is either partially or completely covered. If the surface area is completely covered so thickly that the microscopic interstices between fibers are filled, the effective surface area will actually decrease and reduce evaporation rates. If the underlying structure is completely covered with the impregnating compound, another embodiment of the invention is possible as a variation on the preferred production method. An unsuitable material can be applied to the fibrous material first as an intermediate layer, then completely covered by the impregnating compound, where the term ‘unsuitable material’ is defined as any material used in the art for coating or impregnating contact media that does not have solubility parameters within the ranges disclosed for the impregnating compound, including without limitation the materials disclosed in the Background of the Invention. The final, multi-layer product would exhibit the same performance and advantages as a structure not having the intermediate layer.

The invention has been described in several embodiments. It should be apparent to those skilled in the art that the invention is not limited to these embodiments, but is capable of being varied and modified without departing from the scope of the invention as set out in the attached claims.

1. A water/air contact medium for use in an evaporative cooler, comprising a fibrous material impregnated with a compound having a continuous phase for inhibiting deposition of one or more dissolved or particulate contaminants in the water onto the medium, the continuous phase further comprising a polymer or combination of polymers, the continuous phase having a nonpolar solubility parameter δₙ within the range of about 6.5 to about 8.5 g, a polar solubility parameter δₚ within the range of zero to about 8.5 g, and a hydrogen bond solubility parameter δₕ within the range of zero to about 7.0 g

2. A contact medium as recited in claim 1, wherein the continuous phase also has a surface tension between about 20 and 70 dynes/cm and an interfacial tension with in-service water between zero and about 30 dynes/cm:

3. A contact medium as recited in claim 2, wherein the continuous phase has an overall cationic charge.

4. A contact medium as recited in claim 1, wherein the continuous phase has a nonpolar solubility parameter δₙ within the range of about 6.5 to about 8.5 g-cal/mole, a polar solubility parameter δₚ within the range of about 2.5 to about 7.5 g-cal/mole, and a hydrogen bond solubility parameter δₕ within the range of about 0.7 to about 5.0 g-cal/mole.

5. A contact medium as recited in claim 1, wherein the continuous phase has a nonpolar solubility parameter δₙ within the range of about 6.5 to about 8.5 g-cal/mole, a polar solubility parameter δₚ within the range of about 3.0 to about 5.5 g-cal/mole, and a hydrogen bond solubility parameter δₕ within the range of about 1.0 to about 4.0 g-cal/mole.

6. A contact medium as recited in claim 1, wherein the continuous phase has a surface tension between about 30 and about 68 dynes/cm, and an interfacial tension with in-service water between zero and about 23 dynes/cm.

7. A contact medium as recited in claim 4, wherein the continuous phase has a surface tension between about 30 and about 68 dynes/cm, and an interfacial tension with in-service water between zero and about 23 dynes/cm.

8. A contact medium as recited in claim 5, wherein the continuous phase has a surface tension between about 30 and about 68 dynes/cm, and an interfacial tension with in-service water between zero and about 23 dynes/cm.

9. A contact medium as recited in claim 1, wherein the continuous phase has a surface tension between about 40 and about 68 dynes/cm, and an interfacial tension with in-service water between zero and about 15 dynes/cm.

10. A contact medium as recited in claim 4, wherein the continuous phase has a surface tension between about 40 and about 68 dynes/cm, and an interfacial tension with in-service water between zero and about 15 dynes/cm.

11. A contact medium as recited in claim 5, wherein the continuous phase has a surface tension between about 40 and about 68 dynes/cm, and an interfacial tension with in-service water between zero and about 15 dynes/cm.

12. A contact medium as recited in claim 1, further comprising a discontinuous phase dispersed in the continuous phase.

13. A contact medium as recited in claim 12, wherein the discontinuous phase further comprises fillers, pigments or extenders or combinations thereof.

14. A contact medium as recited in claim 13, wherein the continuous phase and the discontinuous phase together make up between three and about sixty percent of the total weight of the contact media when dry.

15. A contact medium as recited in claim 13, wherein the continuous phase and the discontinuous phase together make up between five and about twenty-five percent of the total weight of the contact media when dry.

16. A contact medium as recited in claim 13, wherein the continuous phase and the discontinuous phase together make up between about ten and about fifteen percent of the total weight of the contact media when dry.

17. A water/air contact medium for use in an evaporative cooler, comprising a fibrous material impregnated with a compound having a continuous phase for inhibiting deposition of one or more dissolved or particulate contaminants in the water onto the medium, the continuous phase further comprising a polymer or combination of polymers, wherein the continuous phase has the following properties: a) a nonpolar solubility parameter δₙ within the range of about 6.5 to about 8.5 g-cal/mole; b) a polar solubility parameter δₚ within the range of zero to about 8.5 g-cal/mole; c) a hydrogen bond solubility parameter δₕ within the range of zero to about 7.0 g-cal/mole; d) a surface tension ranging between about 20 and 70 dynes/cm; and e) an interfacial tension with in-service water ranging between zero and about 30 dynes/cm.

18. A contact medium as recited in claim 17, wherein the plastic polymer has an overall cationic charge.

19. A contact medium as recited in claim 17, wherein the continuous phase has a nonpolar solubility parameter δₙ within the range of about 6.5 to about 8.5 g-cal/mole, a polar solubility parameter δₚ within the range of about 2.5 to about 7.5 g-cal/mole, and a hydrogen bond solubility parameter δₕ within the range of about 0.7 to about 5.0 g-cal/mole.

20. A contact medium as recited in claim 17, wherein the continuous phase has a nonpolar solubility parameter δₙ within the range of about 6.5 to about 8.5 g-cal/mole, a polar solubility parameter δₚ within the range of about 3.0 to about 5.5 g-cal/mole, and a hydrogen bond solubility parameter δₕ within the range of about 1.0 to about 4.0 g-cal/mole.

21. A contact medium as recited in claim 17, wherein the continuous phase has a surface tension between about 30 and about 68 dynes/cm, and an interfacial tension with in-service water between zero and about 23 dynes/cm.

22. A contact medium as recited in claim 17, wherein the continuous phase has a surface tension between about 40 and about 68 dynes/cm, and an interfacial tension with in-service water between zero and about 15 dynes/cm.

23. A contact medium as recited in claim 17, further comprising a discontinuous phase dispersed in the continuous phase.

24. A contact medium as recited in claim 23, wherein the discontinuous phase further comprises fillers, pigments or extenders or combinations thereof.

25. A water/air contact medium for use in an evaporative cooler, comprising: a) a fibrous material; b) an intermediate layer comprising a polymer or unsuitable material deposited on the fibrous material; and c) an impregnating compound deposited on and covering the intermediate layer; the impregnating compound having a continuous phase for inhibiting deposition of one or more dissolved or particulate contaminants in the water onto the medium, the continuous phase further comprising a polymer or combination of polymers, wherein the continuous phase has the following properties: i) a nonpolar solubility parameter δₙ within the range of about 6.5 to about 8.8 g-cal/mole; ii) a polar solubility parameter δₚ within the range of zero to about 8.5 g-cal/mole; iii) a hydrogen bond solubility parameter δₕ within the range of zero to about 7.0 g-cal/mole.; iv) a surface tension ranging between about 20 and 70 dynes/cm; and v) an interfacial tension with in-service water ranging between zero and about 30 dynes/cm.

26. A contact medium as recited in claim 1, wherein the polymer or combination of polymers of the continuous phase is selected from the group consisting of epoxies, polyacetals, polyacrylates, polyacrylics, polyacrylamides, polyalkylamides, polyamides, polyamideimides, polycarbonates, polycarboxylicdihydric esters, polyimides, polyesters, polycellulose acetate butyrates, polydiglycidyletheralkyl/aryldiols, polysilicones, polysiloxanes, polysiloxides, polystyrenes, polysucrose acetate butyrates, polysulfonamides, polysulfones, polyurethanes, polyvinylacetals, and polyvinylhalogens.

27. A contact medium as recited in claim 17, wherein the polymer or combination of polymers of the continuous phase is selected from the group consisting of epoxies, polyacetals, polyacrylates, polyacrylics, polyacrylamides, polyalkylamides, polyamides, polyamideimides, polycarbonates, polycarboxylicdihydric esters, polyimides, polyesters, polycellulose acetate butyrates, polydiglycidyletheralkyl/aryldiols, polysilicones, polysiloxanes, polysiloxides, polystyrenes, polysucrose acetate butyrates, polysulfonamides, polysulfones, polyurethanes, polyvinylacetals, and polyvinylhalogens.

28. A contact medium as recited in claim 25, wherein the polymer or combination of polymers of the continuous phase is selected from the group consisting of epoxies, polyacetals, polyacrylates, polyacrylics, polyacrylamides, polyalkylamides, polyamides, polyamideimides, polycarbonates, polycarboxylicdihydric esters, polyimides, polyesters, polycellulose acetate butyrates, polydiglycidyletheralkyl/aryldiols, polysilicones, polysiloxanes, polysiloxides, polystyrenes, polysucrose acetate butyrates, polysulfonamides, polysulfones, polyurethanes, polyvinylacetals, and polyvinylhalogens.
